(19) United States
(12) Patent Application Publication
(10) Pub. No.: US 2024/0238930 A1
(43) Pub. Date: Jul. 18, 2024

(54) MACHINE TOOL

(71) Applicant: FUJI CORPORATION, Chiryu (JP)

(72) Inventor: Yasuyuki SUZUKI, Toyota-shi (JP)

(73) Assignee: FUJI CORPORATION, Chiryu (JP)

(21) Appl. No.: 18/403,827

(22) Filed: Jan. 4, 2024

(30) Foreign Application Priority Data
Jan. 13, 2023 (JP) 2023-003864

(51) Int. Cl. B23Q 15/22; B23Q 3/155

(52) U.S. Cl. CPC B23Q 15/22; B23Q 3/1552

(57) ABSTRACT

A machine tool includes a display operation device, and a control device to display multiple individual operation buttons and a display switching button on the display operation device and execute control indicated by the multiple individual operation buttons and the display switching button in accordance with an operation performed on the multiple individual operation buttons and the display switching button. The multiple individual operation buttons are buttons to provide an instruction of a series of operations executed by the machine tool in multiple stages. The control device displays button information indicating the individual operation button in accordance with a state of the machine tool among the multiple individual operation buttons on the display switching button, switches the button information displayed on the display switching button in accordance with an operation of executing the display switching button, and switches the button information in order of the series of operations.

### TECHNICAL FIELD

The present disclosure relates to display processing of an operation in a machine tool.

### BACKGROUND ART

The following Patent Literature 1 describes a press system that changes display contents of an operation panel according to an operation of a user. The press system of Patent Literature 1 displays a guidance menu selected by the user on a guidance menu display section, and displays a guidance message corresponding to a related operation related to the guidance menu on a guidance message display section. The operation panel is provided with multiple individual operation switches and a switching screen state display section below the guidance message display section. When one of the multiple individual operation switches is operated, the press system displays a function corresponding to the operated individual operation switch on the switching screen state display section.

### PATENT LITERATURE

Patent Literature 1: JP-UM-A-H5-53798

### BRIEF SUMMARY

### Technical Problem

In the machine tool, multiple actuators and multiple motors are appropriately operated to execute a series of operations. For example, the machine tool executes the series of operations by controlling the multiple actuators and the like in a case where a tool for exchanging is carried from a tool magazine to a tool spindle device or in a case where a used tool is returned from the tool spindle device to the tool magazine. When an error or the like occurs during such a series of operations and the machine tool stops, the user needs to operate the operation panel to return the machine tool to a predetermined state. However, when the series of operations is complicated and the number of buttons to be operated is increased, a procedure from the stopped state to the recovery becomes difficult, and a work load on the user increases.

The present disclosure has been made in view of the above problem, and an object thereof is to provide a machine tool capable of reducing an operation load until a state is restored when the machine tool stops during a series of operations executed by the machine tool.

### Solution to Problem

In order to solve the above problem, according to an aspect of the present specification, there is provided a machine tool including: a display operation device; and a control device configured to display multiple individual operation buttons and a display switching button on the display operation device and execute control indicated by the multiple individual operation buttons and the display switching button in accordance with an operation performed on the multiple individual operation buttons and the display switching button, in which the multiple individual operation buttons are buttons configured to provide an instruction of a series of operations executed by the machine tool in multiple stages, and the control device displays button information indicating the individual operation button in accordance with a state of the machine tool among the multiple individual operation buttons on the display switching button, switches the button information displayed on the display switching button in accordance with an operation of executing the display switching button, and switches the button information in order of the series of operations.

### Advantageous Effects

With the machine tool of the present disclosure, the control device displays the button information indicating the individual operation button in accordance with the state of the machine tool on the display switching button, for example, when an error occurs and the operation stops. The control device switches the button information to be displayed on the display switching button in the order of the series of operations in accordance with the operation of executing the display switching button. Accordingly, the control device displays the button information in accordance with the execution order of the series of operations on the display switching button. By executing the display switching button every time the display of the button information is switched, the user can sequentially execute the stage executed by the machine tool in the series of operations. Accordingly, it is possible to reduce an operation load until the user returns the state.

### BRIEF DESCRIPTION OF DRAWINGS

FIG. 1 is a perspective view of a machine tool according to the present embodiment as viewed from a front surface.

FIG. 2 is a block diagram of the machine tool.

FIG. 3 is a view illustrating a state where a device cover of the machine tool in FIG. 1 is removed.

FIG. 4 is a perspective view of a combined machining machine.

FIG. 5 is a perspective view of an automatic tool exchanging device as viewed from a back side of a machine body.

FIG. 6 is a side view illustrating a state in which a tool is moved by a front-rear shifter.

FIG. 7 is a perspective view illustrating a tool shifter at a lifted position.

FIG. 8 is a perspective view illustrating the tool shifter at a lowered position.

FIG. 9 is a perspective view illustrating a tool changer tool exchange unit.

FIG. 10 is a diagram for illustrating an extraction operation and a return operation.

FIG. 11 is a diagram illustrating a button operation screen for the extraction operation.

FIG. 12 is a diagram illustrating a button operation screen for the return operation.

### DESCRIPTION OF EMBODIMENTS

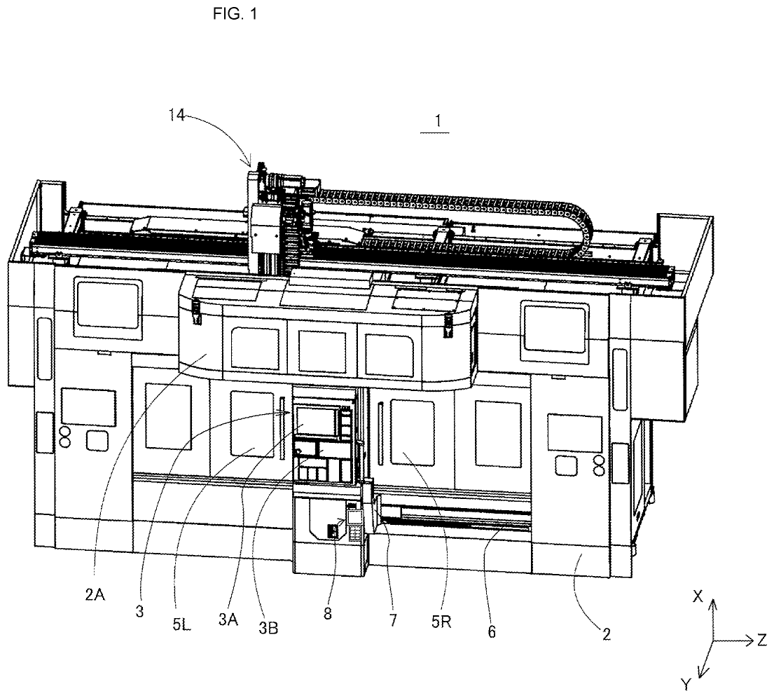

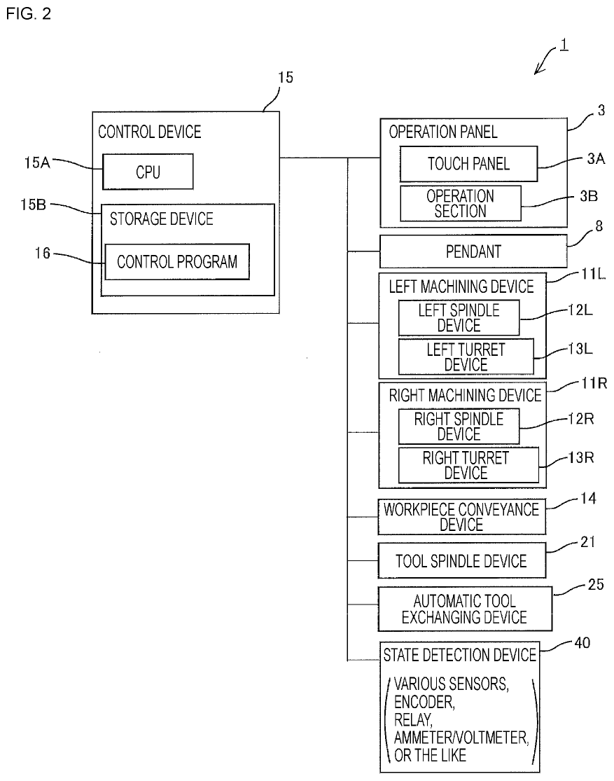

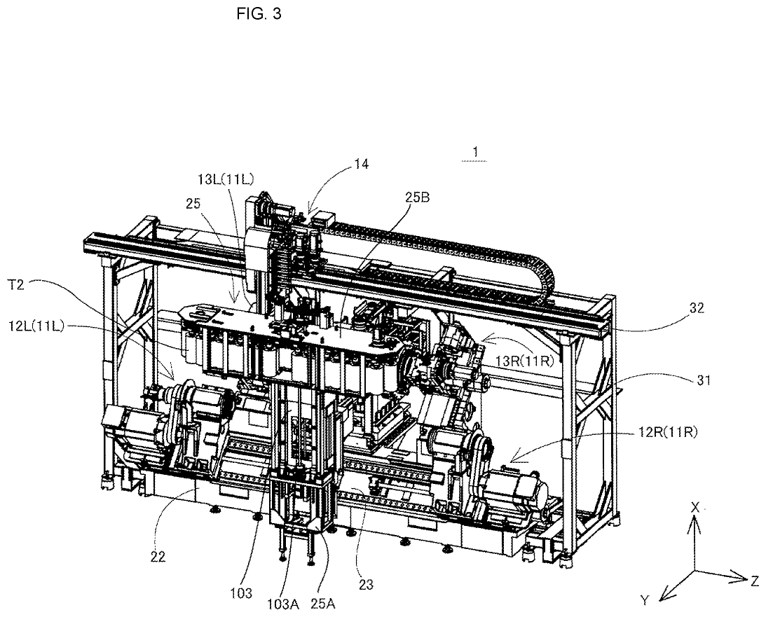

Hereinafter, an embodiment of a machine tool of the present disclosure will be described in detail with reference to the accompanying drawings. FIG. 1 is a perspective view of machine tool 1 of the present embodiment as viewed from a front surface. FIG. 2 illustrates a block diagram of machine tool 1. FIG. 3 illustrates a state where device cover 2 (refer to FIG. 1) of machine tool 1 is removed. In the following description, as illustrated in FIG. 1, the description will be made by referring, with a direction when machine tool 1 is viewed from the front surface as a reference, a right direction, which is a machine width direction and is a direction horizontal to an installation surface of the device, to as a Z direction, a front direction, which is parallel to the installation surface of the device and perpendicular to the Z direction, to as a Y direction, and an up direction, which is perpendicular to the Z direction and the Y direction, to as an X direction. In the following description, a character [L] is generally added to a sign related to the device disposed on a left side of machine tool 1, and a character [R] is added to a sign related to the device disposed on a right side of machine tool 1.

### (Configuration of Machine Tool 1)

As illustrated in FIGS. 1 and 2, the front surface of machine tool 1 is covered with device cover 2, and movable operation panel 3 is disposed on a front surface of the machine. Device cover 2 is provided with left front door 5L on the left side and is provided with right front door 5R on the right side of machine tool 1. Left and right front doors 5L and 5R are, for example, slide doors, and can access a machining space behind the doors by opening the doors.

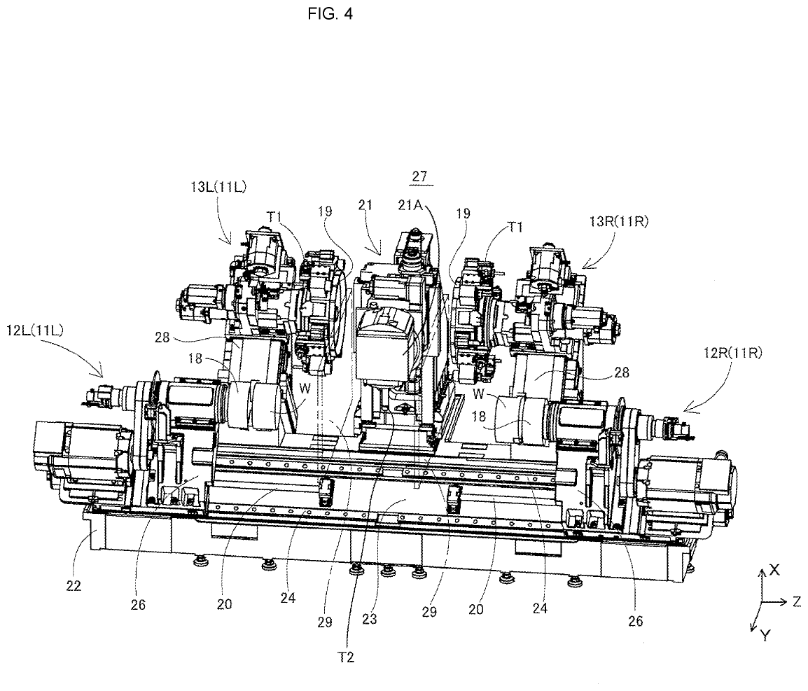

FIG. 4 is a perspective view of combined machining machine 27 provided in machine tool 1. As illustrated in FIGS. 2 to 4, machine tool 1 includes left machining device 11L, right machining device 11R, workpiece conveyance device 14, and control device 15 in addition to operation panel 3. Left machining device 11L and a machining space for left machining device 11L are provided behind left front door 5L illustrated in FIG. 1. Left machining device 11L is, for example, a turret-type lathe, and includes left spindle device 12L and left turret device 13L. Left spindle device 12L is assembled with chuck mechanism 18 (refer to FIG. 4) that grips workpiece W (refer to FIG. 4) which is a machining target or releases the gripping. In FIG. 3, chuck mechanism 18 and workpiece W are not illustrated. As chuck mechanism 18, for example, multiple chuck claws that clamp workpiece W or a collet chuck can be adopted. Left spindle device 12L rotates workpiece W about an axis parallel to the Z direction. Left turret device 13L has turret 19 (refer to FIG. 4) to which multiple tools T1 (turret tool, rotary tool, and cutting tool) illustrated in FIG. 4 can be attached, and executes indexing of tools T1. Left turret device 13L executes machining (cutting, drilling, or the like) on workpiece W gripped by left spindle device 12L by indexed tool T1.

Further, right machining device 11R and a machining space for right machining device 11R are provided behind right front door 5R illustrated in FIG. 1. Right machining device 11R has the same configuration as left machining device 11L, although orientations of right machining device 11R and left machining device 11L are symmetrical in a left-right direction. Therefore, in the descriptions of right machining device 11R, the same contents as those of left machining device 11L will be omitted. Right machining device 11R includes right spindle device 12R and right turret device 13R. The spindle of right spindle device 12R is parallel to the Z direction and faces (opposes) the spindle of left spindle device 12L of left machining device 11L in the left-right direction. Therefore, left and right machining devices 11L and 11R are so-called facing biaxial-type lathes disposed symmetrically in the left-right direction. Right machining device 11R machines workpiece W gripped by right spindle device 12R with tool T1 of right turret device 13R. In addition, right machining device 11R need not have the same configuration as left machining device 11L. For example, at least one of left machining device 11L and right machining device 11R may be another type of machining device, such as a machining center.

Machine tool 1 has both functions of an NC lathe and a machining center. As illustrated in FIG. 4, tool spindle device 21 is provided at the center of a machine body of machine tool 1 to perform machining that is difficult to perform with left and right machining devices 11L and 11R, which are lathes. Machine tool 1 includes combined machining machine 27 (refer to FIG. 4) including left and right machining devices 11L and 11R, and tool spindle device 21 on one bed 22. Bed 22 has, for example, a slant bed structure. Inclined surface 23 inclined forward and downward is formed on the front surface of bed 22. Inclined surface 23 is provided with ball screw mechanism 20 and pair of guide rails 24 provided with ball screw mechanism 20 interposed therebetween.

Left and right spindle devices 12L and 12R are mounted on spindle slide 26 that slides by ball screw mechanism 20, and can slide in a direction parallel to the Z direction along pair of guide rails 24 (inclined surfaces 23) by driving ball screw mechanism 20. Both left and right turrets 13L and 13R and tool spindle device 21 are movable in a front-rear direction of the machine body and an up-down direction of the machine body orthogonal to the spindle (in the Z direction). In particular, while the movement direction of tool spindle device 21 is the horizontal Y direction and the vertical X direction, the movement directions of left turret 13L and right turret 13R are a YL direction and an XL direction in which the Y direction and the X direction are inclined by 45 degrees by turret slide mechanism 28.

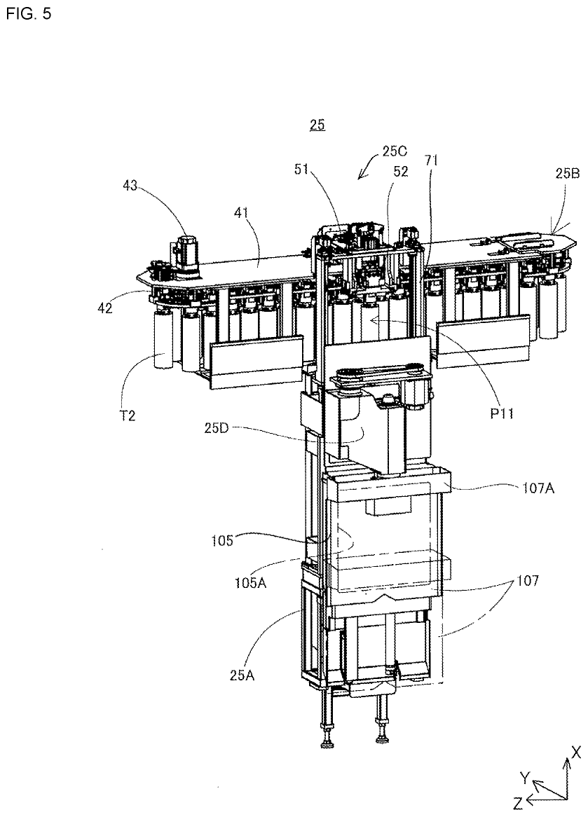

As illustrated in FIG. 3, automatic tool exchanging device 25 is provided in front of machine tool 1. Tool spindle device 21 is provided at the center of machine tool 1 in the Z direction, and can replace tool T2 (spindle head tool, refer to FIG. 4) between automatic tool exchanging device 25 and tool spindle device 21. Tool T2 is an example of a tool of the present disclosure, and is, for example, a drill or an end mill. The tool of the present disclosure is not limited to an integral cutting tool such as a drill or an end mill, and may be a tool in which a cutting blade is separable such as a stepped tool to which a cutting blade is attached. As illustrated in FIG. 4, in tool spindle device 21, a servo motor for a spindle or a tool spindle is incorporated inside spindle head 21A, and various tools T2 housed in automatic tool exchanging device 25 can be replaced with a tool mounting section provided at a lower end portion thereof. As illustrated in FIG. 3, automatic tool exchanging device 25 includes exchanging device main body 25A standing on an installation surface, tool magazine 25B provided on an upper portion of exchanging device main body 25A, shift device 25C (refer to FIG. 5) that moves tool T2, and tool changer 25D (refer to FIG. 5) that exchanges tool T2. Tool magazine 25B is disposed above tool spindle device 21 and on the front side of machine tool 1. Details of automatic tool exchanging device 25 will be described later. Although tools T2 illustrated in each drawing are all cylindrical in shape, this is merely represented by omitting various tools T2 without specifically illustrating the tools.

In addition, machine tool 1 is capable of simultaneously machining workpiece W by left machining device 11L and right machining device 11R, and exchanging tool T2 in tool spindle device 21. As illustrated in FIG. 4, machine tool 1 includes pair of separation shutters 29 disposed on both left and right sides of tool spindle device 21 in the Z direction. Machine tool 1 can individually move two separation shutters 29 in the Y direction by a driving mechanism (not illustrated). Machine tool 1 separates the machining space of each of left machining device 11L and right machining device 11R and a tool exchanging space of tool spindle device 21 by two separation shutters 29. Further, by closing only one of separation shutters 29, the space including the tool exchanging space can be used as the machining space of left machining device 11L.

As illustrated in FIGS. 1 and 3, workpiece conveyance device 14 is, for example, a gantry type workpiece conveyance device, has traveling rail 32 and the like supported by frame structure 31, and can move a head (not illustrated) in each of the X, Y, and Z directions. Workpiece conveyance device 14 executes delivery of workpiece W between left and right machining devices 11L and 11R, an inlet device for carrying in workpiece W, an outlet device for discharging workpiece W, or and the like, and the head. Further, left and right spindle devices 12L and 12R can directly deliver workpiece W by sliding in a direction approaching each other in the Z direction. As illustrated in FIGS. 1 and 2, operation panel 3 is provided on the front surface of device cover 2 and includes touch panel 3A and operation section 3B. Rail 6 along a direction parallel to the Z direction is provided on a lower right portion of the front surface of device cover 2. Operation panel 3 is attached to holding member 7 attached to rail 6, and is movable in the Z direction from the center to the right end of the device front surface along rail 6 together with holding member 7. Operation panel 3 is rotatable in the left-right direction about a rotation axis parallel to the X direction in a state of being held by holding member 7. Operation section 3B includes, for example, an operation switch, a push button (such as an execution button described later), a dial, and a display lamp. Operation panel 3 receives an operation input to touch panel 3A or operation section 3B from a user, and outputs a signal corresponding to the received operation input to control device 15. Operation panel 3 changes the display content of touch panel 3A and the lighting state of the display lamp of operation section 3B based on the control of control device 15. Pendant 8 for operating machine tool 1 can be suspended below the center of device cover 2.

As illustrated in FIG. 2, control device 15 of machine tool 1 includes CPU 15A and storage device 15B, and is a processing device mainly including a computer. Storage device 15B includes, for example, RAM, ROM, a flash memory, and the like. The configuration of storage device 15B is not limited to the above-described configuration, and may be another storage device such as an HDD or an SSD, an external storage device such as a USB memory, a storage medium such as a DVD-RAM, or a combination thereof. Control device 15 is electrically connected to each device (left machining device 11L, workpiece conveyance device 14, or the like) to be able to control each device. Storage device 15B stores control program 16. Control program 16 includes, for example, an NC program for controlling the operation of each of left and right machining devices 11L and 11R for machining workpiece W, a program for controlling the operation of workpiece conveyance device 14, a program for controlling the operation of automatic tool exchanging device 25, and a ladder program for ladder circuits for processing various signals.

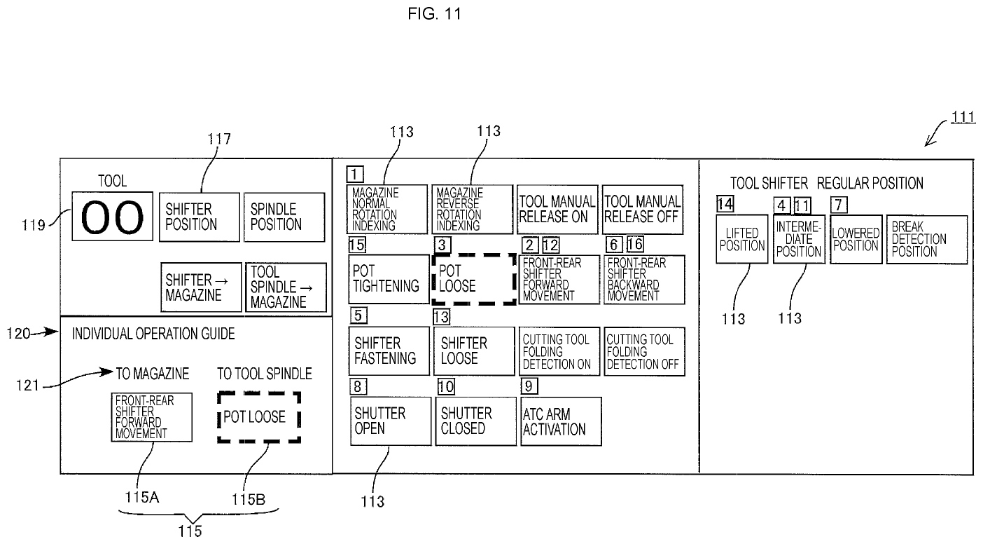

Control program 16 includes a program for determining the state of machine tool 1 described later and a program for switching the display of display switching button 115 (refer to FIG. 11). Control device 15 includes state detection device 40 used to detect the state of machine tool 1. Control device 15 determines the state of machine tool 1 based on a signal or information detected by state detection device 40, and changes the display of display switching button 115 or the like according to the determined state. Details of state determination processing and display switching processing using state detection device 40 will be described later.

### (Automatic Tool Exchanging Device 25)

Next, automatic tool exchanging device 25 will be described. Here, as illustrated in FIGS. 2 and 3, in combined machining machine 27 of the present embodiment, left and right spindle devices 12L and 12R, the left and right turrets 13L and 13R, and tool spindle device 21 are configured to be compact on slant bed type bed 22, thereby enabling space saving. In particular, combined machining machine 27 is designed such that the dimension in the machine body front-rear direction is suppressed, and a moving range of each device is narrowed. That is, a center portion on a machine body front side of combined machining machine 27 serves as the machining chamber, and each device is configured to move between a retracted position and a machining position in a narrow space.

However, when automatic tool exchanging device 25 is disposed at a distant position on bed 22 as in the conventional art and spindle head 21A of tool spindle device 21 is moved to automatic tool exchanging device 25 to perform the exchanging of tool T2, there is a concern that the size of the machining space and the size of the entire combined machining machine 27 may be increased. Accordingly, in machine tool 1 of the present embodiment, the movable range of spindle head 21A is a small distance in the front-rear and up-down directions of the machine body. In order not to impair the effect of combined machining machine 27 in which left and right spindle devices 12L and 12R and the like are compactly disposed, automatic tool exchanging device 25 is configured to exchange tool T2 with tool spindle device 21 having a narrow movable range.

Specifically, FIG. 5 is a perspective view of automatic tool exchanging device 25 as viewed from the back side of the machine body. As illustrated in FIGS. 3 and 5, automatic tool exchanging device 25 is disposed in the center of the front portion of the machine body of machine tool 1, and tool magazine 25B that stores multiple tools T2 so as to enable indexing is provided in the upper portion of the machine body. Shift device 25C of automatic tool exchanging device 25 moves tool T2 between tool magazine 25B located at the upper portion of the machine body and spindle head 21A located at a position lower than tool magazine 25B. Tool magazine 25B is disposed so as to protrude forward from left and right front doors 5L and 5R on the front surface of the machine body, and is covered with magazine cover 2A (refer to FIG. 1).

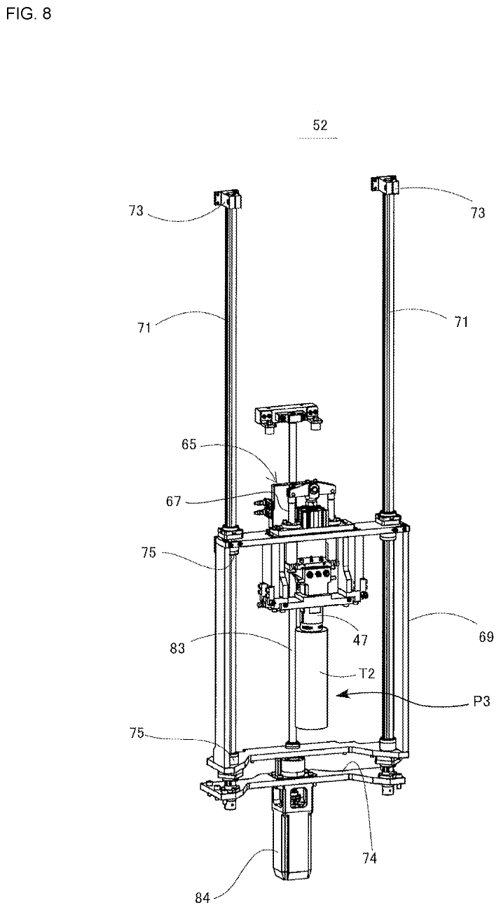

As illustrated in FIG. 5, tool magazine 25B includes top plate 41, roller chain 42, and servo motor 43. Multiple (for example, 40) tools T2 are attached to tool magazine 25B so as to be suspended from top plate 41, and any tool T2 is moved to indexing position P11 provided at a central rear portion in the left-right direction. Tool T2 positioned at indexing position P11 is conveyed to tool exchanging position P3 (refer to FIG. 8) in tool spindle device 21 by shift device 25C and is exchanged. A sprocket (not illustrated) is provided on the lower side of each of both end portions of top plate 41 in the left-right direction. Roller chain 42 has an endless annular shape and is wound around a pair of sprockets. The output shaft of servo motor 43 is coupled to the right sprocket of the pair of sprockets. The rotation operation of servo motor 43 is controlled based on the control of control device 15 to rotate roller chain 42.

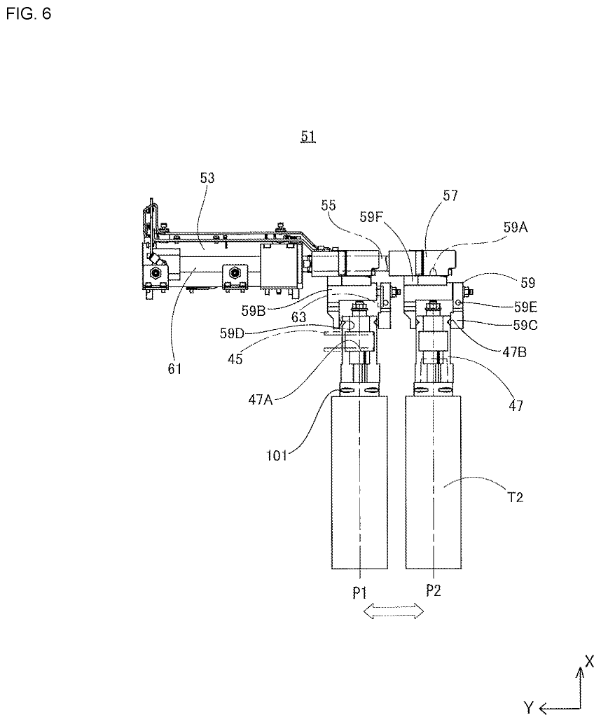

FIG. 6 is a side view illustrating a state in which tool T2 is moved by front-rear shifter 51 described later. As illustrated in FIGS. 5 and 6, roller chain 42 is provided with pot holders 45 at regular intervals. Tool holder 47 for detachably holding tool T2 is detachably attached to each of multiple pot holders 45. Tool T2 is detachably attached to tool holder 47. Pot holder 45 is inserted into gripping hole 47A, and tool holder 47 is held so as to be hooked on roller chain 42. Multiple tool holders 47 (tools T2) stored in tool magazine 25B are attached to annular roller chain 42, are arranged at equal intervals along an oval movement line (circumferential direction), and can be removed toward the outside of the circumference. Tool T2 moves in a movement line (circumferential direction) of roller chain 42 in accordance with the rotation of roller chain 42 in a state of being held by roller chain 42 via tool holder 47 and pot holder 45.

Tool holder 47 is a cap-shaped member fitted to a head portion of tool T2, and is shaped so as to enable handling of tool T2 in roller chain 42 or shift device 25C. Tool T2 fitted to tool holder 47 is held by roller chain 42 in a suspended posture with a machining section such as a cutting edge facing downward. Shift device 25C of automatic tool exchanging device 25 conveys tool T2 to tool exchanging position P3 of tool spindle device 21 in the suspended posture. Shift device 25C includes front-rear shifter 51 for attaching and detaching tool T2 to and from roller chain 42, and tool shifter 52 for moving tool T2 to tool exchanging position P3. Automatic tool exchanging device 25 includes tool changer 25D at tool exchanging position P3 in order to replace tool T2 between spindle head 21A and tool shifter 52.

FIG. 6 illustrates a state in which tool T2 is moved by front-rear shifter 51. Front-rear shifter 51 is assembled to the upper center of tool magazine 25B, and is fixed to top plate 41 in a state in which piston rod 55 of air cylinder 53 protrudes to the rear side (right side in FIG. 6) of the machine body. Pot clamper head 57 is fixed to a distal end of piston rod 55. Front-rear shifter 51 includes pot clamper 59 that is detachable with respect to pot clamper head 57. Pot clamper head 57 is held by guide rod 61 along the front-rear direction in a state where pot clamper 59 is attached, and slides in the front-rear direction by the expansion and contraction of air cylinder 53. A pull clamp (not illustrated) that detachably grips pull bolt 59A provided on an upper surface of pot clamper 59 is provided below pot clamper head 57. In the pull clamp, the amount of tightening pull bolt 59A is adjusted by driving the actuator based on the control of control device 15. Pot clamper head 57 releases pull bolt 59A and releases pot clamper 59 by loosening the pull clamp. Pot clamper head 57 holds pull bolt 59A and holds pot clamper 59 by fastening the pull clamp. Tool holder 47 is configured to be detachable with respect to pot clamper 59.

Front-rear shifter 51 moves tool T2 between front-rear conversion position P1 and up-down conversion position P2 illustrated in FIG. 6. Front-rear conversion position P1 is indexing position P11 illustrated in FIG. 5, and is a position at which the movement of tool T2 in a circumferential direction by roller chain 42 and the movement of tool T2 in the machine body front-rear direction by front-rear shifter 51 are switched. When pot clamper 59 is disposed at front-rear conversion position P1, tool holder 47 of tool T2 indexed at indexing position P11 can be clamped. Pot clamper 59 is assembled to L-shaped fixed block 59B in a state where plate-shaped movable block 59C is displaceable in the front-rear direction, and movable block 59C is normally pulled toward fixed block 59B by a spring. Fixed block 59B and movable block 59C hold clamp protrusions 59D provided on facing inner surfaces by fitting them into clamp grooves 47B of tool holder 47.

Pot clamper 59 holds tool holder 47 so as to clamp tool holder 47 by a biasing force of the spring at up-down conversion position P2. Movable block 59C has locking pins 59E protruding from both sides in a lateral direction orthogonal to the movement direction. When pot clamper 59 is moved from up-down conversion position P2 to front-rear conversion position P1, locking pin 59E abuts on retaining pin 63 protruding downward from top plate 41, whereby the movement of movable block 59C toward fixed block 59B is restricted, and pot clamper 59 is opened at front-rear conversion position P1. At front-rear conversion position P1, pot holder 45 is fitted into gripping hole 47A of tool holder 47 indexed to indexing position P11, and the indexed tool T2 is held by roller chain 42 via tool holder 47. When extracting tool T2 from tool magazine 25B, control device 15 drives air cylinder 53 to move pot clamper 59 to front-rear conversion position P1, drives servo motor 43 to rotate roller chain 42, and arranges tool holder 47 of indexing tool T2 between movable block 59C and fixed block 59B. Control device 15 drives air cylinder 53 to move pot clamper 59 from front-rear conversion position P1 to up-down conversion position P2, closes pot clamper 59, and removes tool holder 47 from pot holder 45. At up-down conversion position P2, front-rear shifter 51 delivers tool holder 47 (tool T2) to and from tool shifter 52. When returning tool T2 to tool magazine 25B, control device 15 moves pot clamper 59 from up-down conversion position P2 to front-rear conversion position P1 to fit pot holder 45 into gripping hole 47A of tool holder 47, releases the clamping by pot clamper 59, and attaches tool T2 to roller chain 42.

At up-down conversion position P2, the conveyance direction of tool T2 is switched between movement in the machine body front-rear direction by front-rear shifter 51 and movement in the machine body up-down direction by tool shifter 52. At the up-down conversion position P2, the transfer of tool T2 by front-rear shifter 51 and tool shifter 52 is performed by the attachment and detachment of pot clamper head 57 and pot clamper 59. Tool T2 disposed at up-down conversion position P2 is exchanged with tool T2 of spindle head 21A of tool spindle device 21 via tool shifter 52 and tool changer 25D.

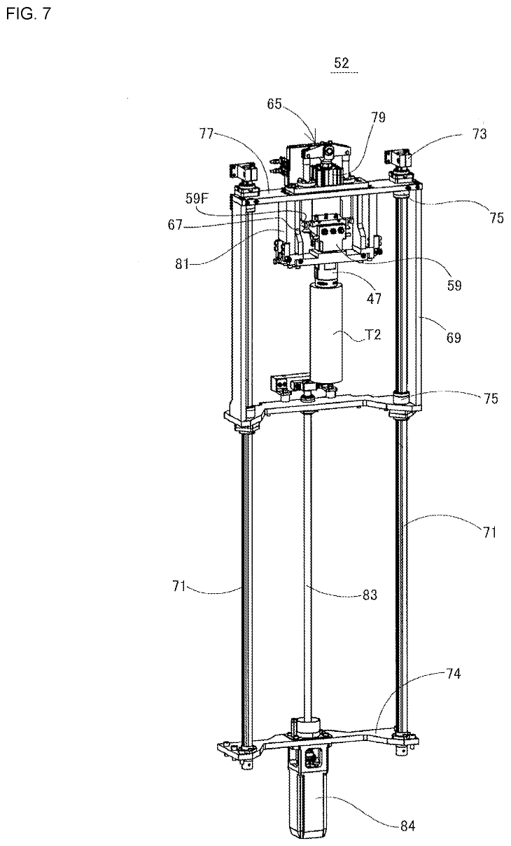

FIG. 7 is a perspective view illustrating tool shifter 52 at the lifted position, and FIG. 8 is a perspective view illustrating tool shifter 52 at the lowered position. Similarly to locking pin 59E, pot clamper 59 includes gripping block 59F protruding to both sides in the lateral direction. When pot clamper 59 is at the lifted position (up-down conversion position P2), clamp pin 67 provided in clamp section 65 of tool shifter 52 is inserted into a cutout portion of gripping block 59F, and thus, pot clamper 59 is grabbed by tool shifter 52. Specifically, in tool shifter 52, clamp section 65 is attached to lifting and lowering frame 69, and clamp section 65 is moved up and down along pair of guide rails 71 along the up-down direction. Pair of guide rails 71 is supported by upper block 73 and lower plate 74 which are fixed to a framework or the like of automatic tool exchanging device 25. Lifting and lowering frame 69 is configured to slide on guide rail 71 by slide sections 75 provided at four positions of upper, lower, left, and right. Clamp section 65 is formed to be assembled to upper beam 77 of lifting and lowering frame 69, so that held tool T2 is housed in the frame.

Clamp pin 67 penetrates a downward cylindrical guide fixed to upper beam 77, is coupled to air cylinder 79 fixed to the upper surface of upper beam 77, and moves in the up-down direction according to the driving of air cylinder 79. Positioning frame 81 for positioning tool holder 47 is fixed to the lower side of upper beam 77. At up-down conversion position P2 illustrated in FIG. 7, tool holder 47 is fitted into a cutout portion (not illustrated) of positioning frame 81, and clamp pin 67 enters the cutout portion of gripping block 59F. In this state, control device 15 drives air cylinder 79 to pull up clamp pin 67, whereby gripping block 59F is clamped by the flange portion at the distal end of clamp pin 67 and the cylindrical guide, and pot clamper 59 is held by clamp section 65.

Tool shifter 52 includes ball screw mechanism 83 that lifts and lowers lifting and lowering frame 69, and drives lifting and lowering servo motor 84 fixed to lower plate 74 to lift and lower lifting and lowering frame 69. Tool shifter 52 drives ball screw mechanism 83 in a state where pot clamper 59 is held by clamp section 65, thereby lowering removing tool T2 to grab pot clamper 59 from pot clamper head 57.

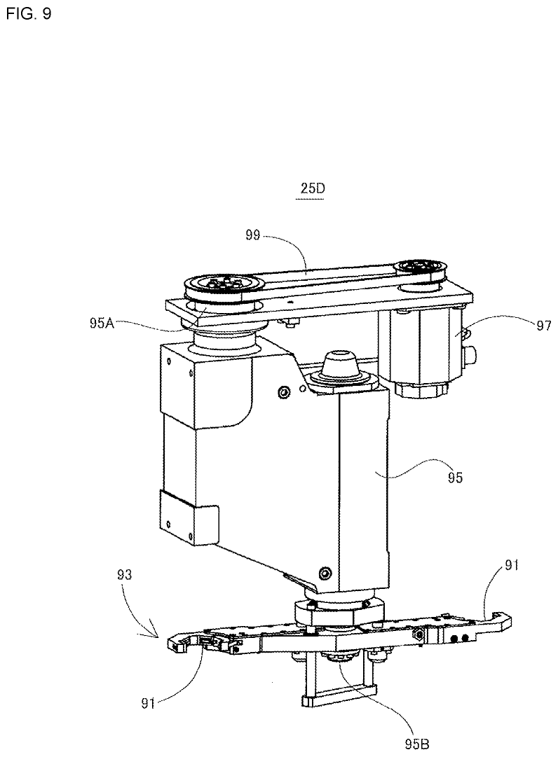

The lowered position of lifting and lowering frame 69 illustrated in FIG. 8 is tool exchanging position P3. Tool changer 25D illustrated in FIG. 9 is provided in accordance with the height of tool exchanging position P3 (lowered position). Tool changer 25D is configured with tool exchange arm 93 having chucks 91 for gripping tool T2 at both end portions, cam device 95 for revolving tool exchange arm 93, revolving servo motor 97 for outputting rotation to cam device 95, and the like. In cam device 95, input shaft 95A protrudes upward, and timing belt 99 is bridged between the output shaft of revolving servo motor 97 and input shaft 95A via a pulley of each shaft.

Cam device 95 is provided with a groove cam, a globoidal cam, or the like (not illustrated) designed to output predetermined movement according to a rotation angle of the input side such that the rotational movement and the up-down movement can be output from output shaft 95B protruding downward by the rotation input from input shaft 95A. Accordingly, control device 15 can adjust a revolving angle and a displacement in the up-down direction of tool exchange arm 93 by controlling the rotation of revolving servo motor 97.

Tool exchange arm 93 is a plate-shaped member extending in a radial direction, and pair of chucks 91 are configured symmetrically with respect to the rotation center. Pair of chucks 91 is provided with a fixed claw and a movable claw. Recessed portion 101 (refer to FIG. 6) into which the protruding portions of the fixed claw and the movable claw are inserted is formed in the neck portion of tool T2. Further, a chuck spring (not illustrated) is incorporated in tool exchange arm 93, and is configured to maintain the open state of the movable claw in a normal state. When tool exchange arm 93 grips tool T2, the position of tool exchange arm 93 in the up-down direction is changed by the driving of revolving servo motor 97, and a lock pin (not illustrated) is inserted into the lock mechanism, whereby the movable claw is fixed at a position where the movable claw grips tool T2. Accordingly, tool exchange arm 93 can remove used tool T2 from spindle head 21A or receive tool for exchanging T2 from tool shifter 52 according to the revolving. Similarly, control device 15 drives revolving servo motor 97 to change the position of tool exchange arm 93 in the up-down direction, thereby releasing the lock by the lock mechanism and releasing the gripping of tool T2 by the fixed claw and the movable claw. Accordingly, tool exchange arm 93 can attach tool for exchanging T2 to spindle head 21A or attach used tool T2 to tool shifter 52 in accordance with the revolving. That is, tool changer 25D exchanges tool T2 held by tool shifter 52 with tool T2 of spindle head 21A by revolving tool exchange arm 93. Further, used tool T2 removed from spindle head 21A is conveyed in a direction (reverse procedure) opposite to the conveyance from tool magazine 25B to spindle head 21A, whereby tool T2 can be returned.

As illustrated in FIG. 3, outer cover 103 of exchanging device main body 25A is provided with viewing window 103A into which glass is fitted. As illustrated in FIG. 5, exchange window 105A is formed in interior cover 105 of exchanging device main body 25A. Tool exchange shutter 107 that opens and closes exchange window 105A in accordance with the exchange of tool T2 is provided on the machining chamber side of exchange window 105A. Tool exchange shutter 107 includes a lifting and lowering air cylinder (not illustrated), and is configured to be lifted to a position indicated by a solid line in FIG. 5 to close exchange window 105A or lowered to a position indicated by a two-dot chain line in FIG. 5 to open exchange window 105A by controlling the lifting and lowering air cylinder by control device 15. Tool exchange shutter 107 is provided with arm storage box 107A for accommodating tool exchange arm 93 of tool changer 25D. When tool T2 is exchanged between tool changer 25D and tool spindle device 21, control device 15 lowers tool exchange shutter 107 to open the exchange window 105A, and tool exchange arm 93 is taken out from arm storage box 107A. Tool changer 25D exchanges tool T2 by revolving tool exchange arm 93. When the exchange of tool T2 is completed, control device 15 lifts tool exchange shutter 107 to close the exchange window 105A, and executes machining or the like by tool spindle device 21.

### (Display Processing of Control Device 15)

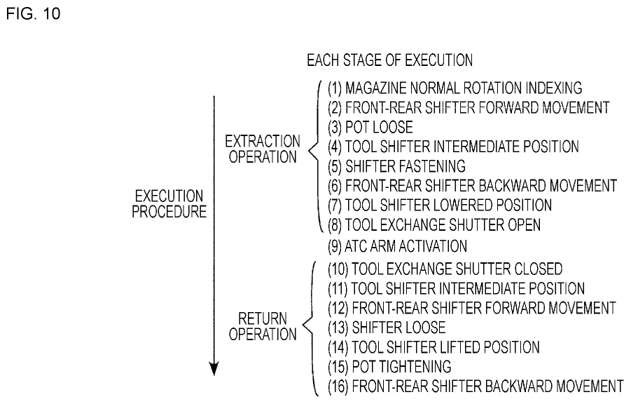

Next, the display processing executed by control device 15 will be described. Here, machine tool 1 performs various operations as described above. Among the various works, there is a work that is executed as a series of operations by appropriately operating multiple actuators, multiple motors, and the like. In the following description, a case where the above-described operation of exchanging tool T2 is adopted as the series of operations will be described. Specifically, as the series of operations, as illustrated in FIG. 10, two operations are adopted, that is, an extraction operation of extracting tool for exchanging T2 from tool magazine 25B and conveying extracted T2 for exchanging to tool exchanging position P3, and a return operation of returning used tool T2 that has been exchanged by tool changer 25D and removed from spindle head 21A to tool magazine 25B. In the following description, the extraction operation will be mainly described, and the same contents as those of the extraction operation will be appropriately omitted in the description of the return operation.

The series of operations according to the present disclosure is not limited to the above-described extraction operation and return operation. As the series of operations, for example, a series of conveyance operations of conveying workpiece W from the inlet device to left spindle device 12L by workpiece conveyance device 14, a series of reversing operations of sliding left and right spindle devices 12L and 12R to deliver (reverse) workpiece W, or a series of machining chamber changing operations of changing the positions of the respective devices of left and right machining devices 11L and 11R and the position of separation shutter 29 to change the machining chamber can be adopted. Also in this case, the extraction operation and the return operation, which will be described later, may be divided into respective stages and executed by individual operation buttons 113, and may be subsequently executed by display switching button 115.

When machine tool 1 stops for some reason during a series of operations such as the exchange of tool T2, the user needs to operate operation panel 3, pendant 8, or the like to return machine tool 1 to a predetermined state. The cause of the stop of the operation is, for example, a case in which an error occurs during the exchange of tool T2, a case in which power disconnection occurs, a case in which the user operates operation panel 3 to proceed to a predetermined stage of the series of operations and stop the operation, or the like. In such a case, for example, it is necessary for the user to proceed one stage from the stopped state and proceed to a predetermined stage in order while confirming whether an error or the like occurs. However, when the series of operations is complicated and the number of buttons to be operated is increased, it is difficult to perform a procedure of returning from a stopped state to a predetermined stage, and the work load of the user is increased. Here, when machine tool 1 stops for some reason in the middle of a series of operations, control device 15 of the present embodiment executes display according to the stopped state, and performs guidance in a stepwise order until the first stage or the last stage of the series of operations.

As illustrated in FIG. 10, the extraction operation and the return operation can be divided into, for example, multiple Stages (1) to (16). Control device 15 executes the display of the guidance in 16 stages. Note that the name of each stage and the method of dividing the stages illustrated in FIG. 10 are examples. FIG. 11 illustrates button operation screen 111 displayed on touch panel 3A of operation panel 3. As illustrated in FIG. 11, control device 15 displays multiple individual operation buttons 113, display switching button 115, and tool selection button 117 on button operation screen 111. In FIG. 11, for easy understanding of the description, numbers corresponding to Stages (1) to (16) illustrated in FIG. 10 are added to each of multiple individual operation buttons 113, but the numbers may be displayed on actual button operation screen 111 or need not be displayed.

Control device 15 displays button operation screen 111 on touch panel 3A according to a predetermined condition. As the predetermined condition, for example, a condition in which an error is resolved after the operation of machine tool 1 is stopped due to an error or the like during the exchange of tool T2 or a condition in which the operation of machine tool 1 is stopped due to an error or the like during the exchange of tool T2 can be adopted. The predetermined condition may be a condition for receiving an operation instruction to display button operation screen 111 on touch panel 3A. The predetermined condition may be a condition in which a power source is turned on again after an error occurs and the power source is turned off in a stopped state. In the following description, a case will be described in which the operation of machine tool 1 is stopped due to an error or the like during the exchange of tool T2, and then the error is resolved and button operation screen 111 is displayed. In this case, by operating individual operation button 113 or display switching button 115, the user can convey tool T2 during the exchange stopped due to an error to tool spindle device 21 and exchange tool T2, or can convey tool T2 to tool magazine 25B and return tool T2.

Control device 15 executes control indicated by each of individual operation buttons 113, display switching button 115, and tool selection button 117 in response to an operation on each of multiple individual operation buttons 113, display switching button 115, and tool selection button 117. Control device 15 displays, for each of multiple individual operation buttons 113 and display switching button 115, a control content (an example of button information of the present disclosure) to be executed when individual operation button 113 or display switching button 115 is selected and executed. In the example illustrated in FIG. 11, characters having the same contents as those in the respective stages illustrated in FIG. 10 or simplified characters are displayed as the button information on individual operation buttons 113 or display switching buttons 115. The button information of the present disclosure is not limited to the character information indicating each stage, and may be a number indicating each of Stages (1) to (16), or may be a diagram (picture) schematically illustrating the state and operation of each stage. Accordingly, the button information displayed on display switching button 115 may correspond to the button information of individual operation button 113, and need not be the same button information.

For example, when any individual operation button 113 is touch-operated, control device 15 changes a color of individual operation button 113 (changes the color to red or yellow), and notifies that individual operation button 113 is selected. Then, when an execution button (a hard key such as a push button) provided in operation section 3B is operated in a state where any individual operation button 113 is selected, control device 15 executes the button information indicated by individual operation button 113 during the selection, that is, the control content of each Stage (1) to (16). By selecting and executing any individual operation button 113 (hereinafter, simply referred to as execution in some cases), the exchange of tool T2 can proceed to any stage among Stages (1) to (16). Control device 15 blinks individual operation buttons 113 during the execution of the control content of selected individual operation buttons 113, and notifies that the control content is being executed. When the execution of the control content is completed, that is, when the state of machine tool 1 transitions to the stage of selected individual operation button 113, control device 15 ends the blinking display and brings machine tool 1 into a state in which none of individual operation buttons 113 is selected. The operation procedure described above is an example. For example, the execution button may be a soft key displayed on touch panel 3A. Alternatively, control device 15 may start the execution only by performing a touch operation on individual operation button 113.

As illustrated in FIG. 10, in the present embodiment, Stages (1) to (8) are set as the extraction operation, and the extraction operation is a series of operations of conveying tool for exchanging T2 from tool magazine 25B to tool exchanging position P3. Stage (1) “magazine normal rotation indexing” illustrated in FIGS. 10 and 11 is a stage of indexing tool for exchanging T2 scheduled to be exchanged when the operation is stopped due to an error to indexing position P11. When the execution of individual operation button 113 of (1) “magazine normal rotation indexing” is received, control device 15 causes individual operation button 113 of (1) “magazine normal rotation indexing” to blink and drives servo motor 43 to index tool T2 to be exchanged at indexing position P11. Further, pot clamper head 57 of front-rear shifter 51 stands by at indexing position P11 in accordance with the indexing of tool T2. When Stage (1) is completed, the indexed tool T2 is in a state in which tool holder 47 is disposed between fixed block 59B and movable block 59C of pot clamper head 57. When the operation of indexing tool T2 to indexing position P11, that is, Stage (1) “magazine normal rotation indexing” is completed, control device 15 ends the blinking display and brings individual operation button 113 into a state of not being selected.

As illustrated in FIG. 11, button operation screen 111 displays two individual operation buttons 113 of “magazine normal rotation indexing” and “magazine reverse rotation indexing”. Two individual operation buttons 113 are an indexing method of reversing the rotation direction of roller chain 42, and in Stage (1), “magazine reverse rotation indexing” may be adopted instead of “magazine normal rotation indexing”. In addition, control device 15 may adopt an indexing direction with high indexing efficiency according to the position of tool T2 stopped due to an error in the execution of display switching button 115 described later.

Next, the other Stages (2) to (16) will be described. With respect to individual operation buttons 113 of the other Stages (2) to (16), the control of each stage can be executed by operating individual operation buttons 113 in the same manner as in the above described (1) “magazine normal rotation indexing”. Therefore, only the states of the other Stages (2) to (16) will be described, and the description of the operation method and the like will be omitted. In addition, for example, in a case where control reverse to any stage is executed, the already described contents will be appropriately omitted.

State (2) “front-rear shifter forward movement” is a stage of moving pot clamper head 57 of front-rear shifter 51 from front-rear conversion position P1 (indexing position P11) to up-down conversion position P2. Control device 15 drives air cylinder 53 to move pot clamper head 57 from front-rear conversion position P1 to up-down conversion position P2. Further, control device 15 arranges clamp section 65 of tool shifter 52 at up-down conversion position P2 in accordance with the execution of Stage (2). When Stage (2) is completed, tool T2 is disposed at up-down conversion position P2, and clamp pin 67 of tool shifter 52 is inserted into the cutout portion of gripping block 59F of the pot clamper 59.

Stage (3) “pot loose” is a stage of loosening a pull clamp (not illustrated) of pot clamper head 57. Control device 15 drives the actuator of pot clamper head 57 to loosen the pull clamp. Accordingly, pot clamper 59 is released from pot clamper head 57 (front-rear shifter 51).

Stage (4) “tool shifter intermediate position” is a stage in which clamp section 65 is lowered slightly below the position of up-down conversion position P2. In Stage (3), clamp section 65 is disposed at up-down conversion position P2 and disposed at a position facing indexing position P11 in the Y direction (front-rear direction). The control device drives lifting and lowering servo motor 84 to slightly lower clamp section 65 from up-down conversion position P2. Thus, pot clamper 59, tool holder 47, and tool T2 are held by clamp section 65.

Stage (5) “shifter fastening” is a stage in which pot clamper 59 is fixed by clamp section 65 at the above-described intermediate position. Control device 15 drives air cylinder 79 to pull up clamp pin 67, thereby fixedly holding pot clamper 59 by clamp section 65. Stage (6) “front-rear shifter backward movement” is, contrary to Stage (2), a stage of moving pot clamper head 57 from up-down conversion position P2 to the front-rear conversion position P1. Control device 15 drives air cylinder 53 to move pot clamper head 57 to front-rear conversion position P1 and retract pot clamper head 57 from clamp section 65.

Stage (7) “tool shifter lowered position” is a stage in which clamp section 65 of tool shifter 52 is disposed at the lowered position, that is, tool exchanging position P3 at which the delivery between tool exchange arm 93 and tool T2 is performed. Control device 15 drives lifting and lowering servo motor 84 to lower clamp section 65 from the intermediate position to the lowered position. Stage (8) “tool exchange shutter open” is a stage of opening tool exchange shutter 107. Control device 15 drives lifting and lowering air cylinder (not illustrated) to lower tool exchange shutter 107 to a position indicated by a two-dot chain line in FIG. 5 to open exchange window 105A. Thus, the extraction operation is completed.

Stage (9) “ATC arm activation” is a stage in which tool T2 is exchanged between clamp section 65 and spindle head 21A by tool exchange arm 93. Control device 15 controls the rotation of revolving servo motor 97 (refer to FIG. 9) to change the rotational position and the position of tool exchange arm 93 in the up-down direction, thereby exchanging tool T2.

As illustrated in FIG. 11, Stages (10) to (16) are set as the return operation in the present embodiment, and are a series of operations of conveying tool T2 from the lowered position (tool exchanging position P3) to tool magazine 25B. In the following description of the return operation, description of the same contents as those of the above-described extraction operation will be appropriately omitted. Stage (10) “tool exchange shutter closed” is, contrary to Stage (8), a stage in which the lifting and lowering air cylinder (not illustrated) is driven to lift tool exchange shutter 107 to the position illustrated by the solid line of FIG. 5 to close exchange window 105A. Stage (11) “tool shifter intermediate position” is a state in which clamp section 65 of tool shifter 52 is lifted from tool exchanging position P3 to the intermediate position and is made to stand by. At this stage, tool T2 removed from spindle head 21A is disposed at the intermediate position (a position slightly lowered from up-down conversion position P2).

Stage (12) “front-rear shifter forward movement” is a stage of moving pot clamper head 57 from front-rear conversion position P1 to up-down conversion position P2. In Stage (12), unlike Stage (2), empty pot clamper head 57 not holding pot clamper 59 (tool T2) is moved to front-rear conversion position P1. This completes preparation for receiving tool T2 from tool shifter 52 to front-rear shifter 51.

Stage (13) “shifter loose” is, contrary to Stage (5), a state in which air cylinder 79 is driven to release the fixing of pot clamper 59 by clamp pin 67. Stage (14) “tool shifter lifted position” is, contrary to Stage (4), a stage in which clamp section 65 is lifted from the intermediate position to up-down conversion position P2. Accordingly, tool holder 47 (tool T2) is located at a position facing front-rear conversion position P1 in the Y direction, and pot holder 45 can be appropriately inserted into gripping hole 47A from the front side in the Y direction.

Stage (15) “pot tightening” is, contrary to Stage (3), a stage in which the actuator of pot clamper head 57 is driven to tighten the pull clamp. Accordingly, tool T2 is attached to pot clamper head 57 and can be conveyed by front-rear shifter 51. Stage (16) “front-rear shifter backward movement” is a stage of moving front-rear shifter 51 from up-down conversion position P2 to front-rear conversion position P1. Thus, pot holder 45 is inserted into gripping hole 47A of tool holder 47, and tool T2 is returned to tool magazine 25B.

Tool selection button 117 is a button for selecting tool T2 and moving selected tool T2 to a predetermined stage. In the example illustrated in FIG. 11, four tool selection buttons 117 and tool number input field 119 for selecting tool T2 are displayed on the left side of individual operation button 113. Tool number input field 119 is a field for inputting an identification number for identifying tool T2 accommodated in tool magazine 25B. When the execution button of operation section 3B is pressed in a state where the identification number is input to tool number input field 119 and any tool selection button 117 is selected, control device 15 conveys tool T2 indicated by the identification number to the position indicated by tool selection button 117. For example, when the execution of tool selection button 117 of the “shifter position” is received, control device 15 extracts tool T2 indicated by the identification number from tool magazine 25B and conveys tool T2 to tool exchanging position P3.

As described above, each of multiple individual operation buttons 113 is a button for providing instructions of the extraction operation and the return operation in multiple stages. The user can proceed to any stage by executing any individual operation button 113. However, when the user wants to check the cause of the error, the failure caused by the error, and the like, the user needs to check the state of the device while sequentially executing each stage. Meanwhile, as illustrated in FIG. 11, multiple individual operation buttons 113 are arranged at the center, the right side, or the like of button operation screen 111, and are arranged in an order different from the order of Stages (1) to (16). This includes, for example, a button that improves operability and visibility and a button that can suppress occurrence of an erroneous operation by collectively displaying individual operation buttons 113 of “magazine normal rotation indexing” and individual operation buttons 113 of “magazine reverse rotation indexing” displayed next to individual operation buttons 113. Alternatively, by collecting and displaying individual operation buttons 113 for operating the position of tool shifter 52 on the right side of button operation screen 111, it is possible to improve operability or the like for tool shifter 52. Therefore, when individual operation buttons 113 are arranged for each of the devices which are operation targets in consideration of operability or the like, a relationship between the order of Stages (1) to (16) and the arrangement of individual operation buttons 113 to be displayed becomes low. As a result, when the operation is stopped at any stage of Stages (1) to (16), the user cannot know which individual operation button 113 at the next stage or the previous stage is. The work time required to check and restore the state of machine tool 1 becomes longer.

Here, control device 15 causes display switching button 115 to display button information indicating individual operation button 113 corresponding to the state of machine tool 1 among multiple individual operation buttons 113. Then, control device 15 switches the button information displayed on display switching button 115 in accordance with the operation of executing display switching button 115, and switches the button information in the order of the series of operations. Specifically, as illustrated in FIG. 11, control device 15 displays individual operation guide screen 120 on the left side of individual operation button 113 and on the lower side of tool selection button 117. Control device 15 displays two display switching buttons 115 of previous stage display switching button 115A and subsequent stage display switching button 115B on individual operation guide screen 120. Previous stage display switching button 115A is display switching button 115 for displaying button information of a previous stage in the order of a series of operations, and subsequent stage display switching button 115B is display switching button 115 for displaying button information of a subsequent stage. Hereinafter, previous stage display switching button 115A and subsequent stage display switching button 115B are collectively referred to as display switching button 115.

For example, when the operation stops due to an error and the generated error is resolved, control device 15 detects the state of machine tool 1 using state detection device 40 (refer to FIG. 2). The state of machine tool 1 is, for example, any one of Stages (1) to (16) or a state between the stages. Therefore, as state detection device 40, a device for detecting a state of which stage of a series of operations and a state between the stages, for example, various sensors, an encoder for detecting a rotational position of a motor, a relay for outputting contact information, an ammeter, a voltmeter, or a combination thereof can be adopted. Control device 15 determines the state of machine tool 1 based on the states of tool magazine 25B and tool changer 25D, the information of tool T2 during use stored in storage device 15B, and the like using state detection device 40. In FIG. 2, in order to avoid complication of the drawing, state detection device 40 is illustrated as one block.

In the extraction operation and the return operation, the actuators such as pot clamper head 57 and tool exchange arm 93, and the driving sources such as air cylinder 53 and lifting and lowering servo motor 84 are operated. State detection device 40 may be, for example, a position sensor that detects the positions of the pot clamper head 57 and tool exchange arm 93. State detection device 40 may be, for example, a cylinder switch that detects the position of the piston of air cylinder 53. As state detection device 40, an encoder that detects a rotational position of lifting and lowering servo motor 84, a linear scale that detects a position of ball screw mechanism 83 or the lifting and lowering frame 69 in the up-down direction, or the like can be adopted.

FIG. 11 illustrates a case where state detection device 40 detects that state detection device 40 stops in a state between (2) front-rear shifter forward movement and (3) pot loose among Stages (1) to (16). In this case, control device 15 determines that the state of machine tool 1 is the state between Stages (2) and (3) based on the state detected by state detection device 40. Control device 15 displays button information (characters of “front-rear shifter forward movement”) indicating (2) “front-rear shifter forward movement”, which is a previous stage of the determined state, on previous stage display switching button 115A, and displays button information indicating (3) “pot loose”, which is a subsequent stage, on subsequent stage display switching button 115B. Accordingly, the stages before and after the stopped state can be automatically displayed on display switching button 115. The user can transition the state of machine tool 1 from the stopped state to the previous and subsequent stages by operating display switching button 115.

When the state detected by state detection device 40 is a specific stage, control device 15 may display stages before and after the specific stage on display switching button 115. For example, when state detection device 40 determines that the machine tool has stopped in the state of Stage (3) “pot loose”, control device 15 may display Stage (2) “front-rear shifter forward movement” on previous stage display switching button 115A and display Stage (4) “tool shifter intermediate position” on subsequent stage display switching button 115B.

As a result of the determination by state detection device 40, when the stopped state is unknown, control device 15 does not display the button information of previous stage display switching button 115A and subsequent stage display switching button 115B. For example, there is a possibility that control device 15 cannot determine the state of machine tool 1, such as when the sensor fails or when the signal line is disconnected. In this case, for example, control device 15 does not display characters on two display switching buttons 115. Accordingly, it is possible to cause the user to recognize the occurrence of the failure in which the state cannot be determined on machine tool 1 side in the non-display state of display switching button 115. When the stopped state is unknown, control device 15 may display a message such as “display switching button 115 cannot be displayed because the state cannot be detected” on button operation screen 111 in addition to the non-display of display switching button 115.

Control device 15 switches the button information displayed on previous stage display switching button 115A and subsequent stage display switching button 115B in accordance with the operation of executing previous stage display switching button 115A and subsequent stage display switching button 115B, and switches the button information in the order of the series of operations. As indicated by a thick broken line in FIG. 11, for example, when subsequent stage display switching button 115B is touched and selected, control device 15 changes the color of subsequent stage display switching button 115B and notifies the user of the selection. When the execution button of operation section 3B is pressed in a state in which subsequent stage display switching button 115B is selected, control device 15 executes control of transitioning the state to Stage (Stage (3) in the example of FIG. 11) of the button information indicated by subsequent stage display switching button 115B. When control device 15 completes the control to transition the state to Stage (3), control device 15 changes the button information of previous stage display switching button 115A to Stage (4) “tool shifter intermediate position” which is the next stage. Further, control device 15 changes the button information of previous stage display switching button 115A to Stage (3). Accordingly, when subsequent stage display switching button 115B is executed, the button information of previous stage display switching button 115A and subsequent stage display switching button 115B is advanced by one. Further, control device 15 maintains the state in which subsequent stage display switching button 115B is selected. The user can advance the state of machine tool 1 to next Stage (4) by pressing the execution button again. The user can advance the state of machine tool 1 to desired Stage (for example, Stage (9) or the like) by repeatedly pressing the execution button.

Similarly, when control device 15 receives an operation to execute previous stage display switching button 115A, control device 15 executes control to transition the state to the button information (Stage (2) in the example of FIG. 11) indicated by previous stage display switching button 115A. When control device 15 completes the control and transitions to the previous stage, control device 15 changes the button information of previous stage display switching button 115A to Stage (1) and changes the button information of subsequent stage display switching button 115B to Stage (2). Accordingly, when previous stage display switching button 115A is executed, the button information of previous stage display switching button 115A and subsequent stage display switching button 115B is returned by one. The user can return the state of machine tool 1 to a desired stage by repeatedly executing previous stage display switching button 115A, similarly to subsequent stage display switching button 115B. Accordingly, the user can sequentially advance each stage of the complicated series of operations only by selecting previous stage display switching button 115A and subsequent stage display switching button 115B and continuously pressing the execution button. In a case where the state detected by state detection device 40 is first Stage (1), or in a case where the state reaches Stage (1) by the operation of the user, control device 15 need not display previous stage display switching button 115A because there is no previous stage. Similarly, in the case of last Stage (16), since there is no subsequent stage, control device 15 need not display subsequent stage display switching button 115B.

When the execution of display switching button 115 is received, control device 15 transitions the state of machine tool 1 to a stage corresponding to individual operation button 113 indicated by the button information being displayed on display switching button 115, and does not change the button information being displayed on display switching button 115 during the state transition. For example, control device 15 accepts the execution of subsequent stage display switching button 115B, and maintains the button information of subsequent stage display switching button 115B as “pot loose” during the transition to Stage (3). When the transition to Stage (3) is completed, control device 15 sets the button information of subsequent stage display switching button 115B to next Stage (4) “tool shifter intermediate position”. Accordingly, not only by blinking display switching button 115 but also by displaying the button information, it is possible to notify whether display switching button 115 is being executed (whether state is transitioning or control is being executed). The occurrence of erroneous operation of the execution button or the like can be suppressed.

For example, when display switching button 115 is selected, control device 15 sets a display state indicating that individual operation button 113 having the same character as the button information of selected display switching button 115 is selected. For example, as indicated by a thick broken line in FIG. 11, when subsequent stage display switching button 115B displaying Stage (3) “pot loose” is touched, control device 15 changes the color of subsequent stage display switching button 115B to red and also changes the color of individual operation button 113 displaying the characters “pot loose” to red. That is, the display of individual operation button 113 is also changed in conjunction with the change of the display of display switching button 115. Accordingly, as a result of operating display switching button 115, the user can recognize which position of individual operation button 113 is selected and executed.

In addition, as illustrated in FIG. 11, control device 15 displays multiple individual operation buttons 113 and display switching button 115 side by side in one screen (button operation screen 111). When control device 15 receives the operation of executing display switching button 115, control device 15 sets individual operation button 113 indicated by the button information of display switching button 115 to the display mode in which individual operation button 113 is being executed. As indicated by a thick broken line in FIG. 11, for example, in a case where subsequent stage display switching button 115B is executed, individual operation button 113 having the same character information as the character information (pot loose) displayed on subsequent stage display switching button 115B is also displayed as being executed. While the control of subsequent stage display switching button 115B is being executed, control device 15 sets both subsequent stage display switching button 115B and individual operation buttons 113 corresponding thereto to the blinking state. When the execution is completed, control device 15 switches the display of subsequent stage display switching button 115B to Stage (4), and returns the display (red or the like) indicating that individual operation button 113 of Stage (3) “pot loose” is being selected to the normal state. Accordingly, when display switching button 115 is executed, it is possible to confirm at which position individual operation button 113 is being executed in one screen. In addition, in accordance with the switching of the display of subsequent stage display switching button 115B to Stage (4), control device 15 changes both the colors of subsequent stage display switching button 115B and individual operation buttons 113 of Stage (4) “tool shifter intermediate position” to a display indicating that selection is being performed such as red. Control device 15 may execute at least one of the processing of changing the display of individual operation button 113 to “in selection” in accordance with the selection of display switching button 115 and the processing of changing the display of individual operation button 113 to “in execution” in accordance with the execution of display switching button 115.

In addition, control device 15 displays the information indicating the first stage of the series of operations around previous stage display switching button 115A, and displays the information indicating the last stage of the series of operations around subsequent stage display switching button 115B. Specifically, as illustrated in FIG. 10, in the case of the extraction operation, the first stage is Stage (1) “magazine indexing”. Therefore, for example, control device 15 displays characters 121 of “to magazine” on previous stage display switching button 115A. In the case of the extraction operation, the last stage is Stage (8) “shutter open”, which is the work on spindle head 21A side. Therefore, for example, control device 15 displays characters 121 of “to tool spindle” on subsequent stage display switching button 115B. Accordingly, the user can correctly recognize which of previous stage display switching button 115A and subsequent stage display switching button 115B is the button for carrying tool T2 to which of tool magazine 25B or spindle head 21A.

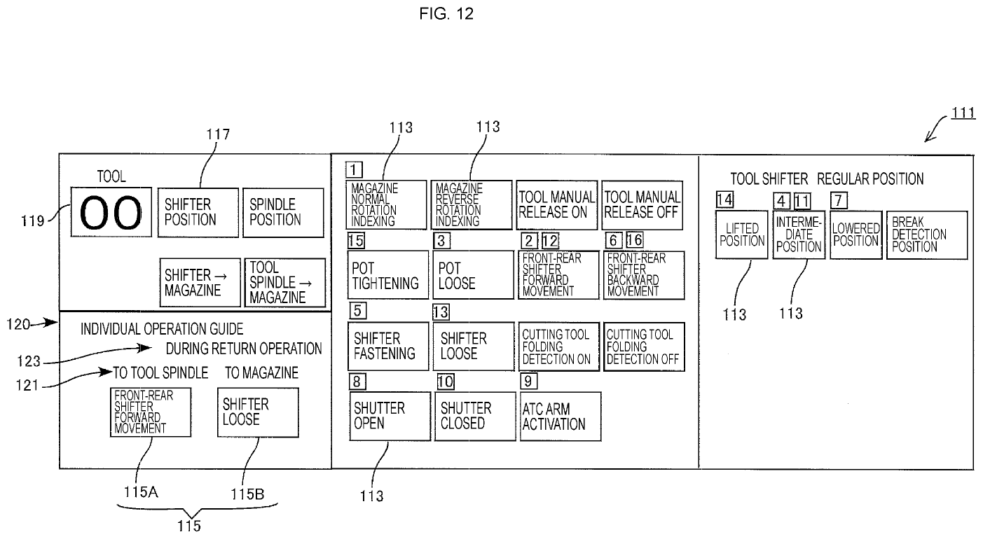

FIG. 12 illustrates, as an example, a display state in a case where the return operation is stopped between Stages (12) and (13). As illustrated in FIG. 12, in the case of the return operation, since the first stage is Stage (10) (on spindle head 21A side), control device 15 displays characters 121 of “to tool spindle” on previous stage display switching button 115A. Further, since the last stage is Stage (16) (tool magazine 25B side), control device 15 displays characters 121 of “to magazine” on subsequent stage display switching button 115B. Accordingly, even in the return operation, the user can correctly recognize which of previous stage display switching button 115A and subsequent stage display switching button 115B is the button for carrying tool T2 to which thereof. Note that control device 15 may display whether the current state of machine tool 1 is in the extraction operation or in the return operation with characters. For example, as illustrated in FIG. 12, when control device 15 stops during the return operation and displays display switching button 115, control device 15 may display characters 123 of “during return operation” on the character 121. Similarly, control device 15 may display characters of “during extraction operation” in the extraction operation illustrated in FIG. 11.

In addition, control device 15 may change the display of characters 121 in accordance with continuous execution from the extraction operation to the return operation. For example, when the execution of Stage (8) illustrated in FIG. 10, that is, the last stage of the extraction operation is completed, control device 15 changes the button information of previous stage display switching button 115A to Stage (8) and changes the button information of subsequent stage display switching button 115B to Stage (9). At this time, the display of characters 121 may be maintained as it is or need not be displayed. When the execution of Stage (9) is completed, as illustrated in FIG. 12, control device 15 switches characters 121 above previous stage display switching button 115A and subsequent stage display switching button 115B. Further, control device 15 maintains the state in which subsequent stage display switching button 115B is selected. Accordingly, the user can continuously execute a series of operations from the extraction operation to the return operation by continuously pressing the execution button after selecting subsequent stage display switching button 115B. It should be noted that control device 15 may switch previous stage display switching button 115A and subsequent stage display switching button 115B without switching the positions of characters 121 between the extraction operation and the return operation.

Further, in the present embodiment, the extraction operation and the return operation of tool T2 are adopted as a series of operations, and the display of display switching button 115 is switched. Machine tool 1 of the present embodiment has a structure in which automatic tool exchanging device 25 exchanges tool T2 for tool spindle device 21 having a narrow movable range so as not to impair the effect of combined machining machine 27 in which left and right spindle devices 12L and 12R and the like are compactly arranged. With such a structure, the size of machine tool 1 can be reduced, but the exchanging operation may be complicated. Therefore, it is extremely effective to switch the display of display switching button 115 for a series of operations of exchanging tool T2 in machine tool 1 in which the exchanging operation of tool T2 is complicated by downsizing the device. Control device 15 may execute the processing of switching the display of display switching button 115 for only one of the extraction operation and the return operation as the series of operations.

In the above embodiment, operation panel 3 is an example of a display operation device. Button operation screen 111 is an example of a screen. Tool T2 is an example of a tool. Characters 121 are an example of information indicating the first stage of the series of operations and information indicating the last stage of the series of operations.

As described above, according to the present embodiment described above, the following advantageous effects can be achieved.
Control device 15 according to an aspect of the present embodiment executes control according to an operation on each of individual operation buttons 113 and display switching button 115. Control device 15 causes display switching button 115 to display button information indicating individual operation button 113 corresponding to the state of machine tool 1 stopped due to an error or the like. Control device 15 switches the button information displayed on display switching button 115 in accordance with the operation of executing display switching button 115, and switches the button information in the order of the series of operations. Accordingly, control device 15 displays, on display switching button 115, button information corresponding to the execution order of the extraction operation and the return operation. By executing display switching button 115 every time the display of the button information is switched, the user can sequentially execute the stage executed by machine tool 1 in the series of operations. As a result, it is possible to reduce the operation load until the user returns the state.

The present disclosure is not limited to the above-described embodiment, and it is needless to say that various improvements and modifications can be made without departing from the gist of the present disclosure.
For example, in the above-described embodiment, touch panel 3A and operation section 3B of operation panel 3 are adopted as the display operation device of the present disclosure, however, the configuration is not limited to this. The display operation device of the present disclosure may have a configuration including only touch panel 3A, or may have a configuration not including touch panel 3A such as the liquid crystal and the hard keys. The display operation device may be a portable device such as a tablet capable of communicating with pendant 8 or machine tool 1. In the above embodiment, individual operation buttons 113 and display switching button 115 are displayed in the single button operation screen 111, but may be displayed on separate screens, screens before and after switching, or the like.
Control device 15 does not change the button information of display switching button 115 while display switching button 115 is being executed, however, the configuration is not limited to this. For example, when the execution is started, control device 15 may update the button information of previous stage display switching button 115A or subsequent stage display switching button 115B.
Control device 15 may be configured to display only one of previous stage display switching button 115A and subsequent stage display switching button 115B.

Machine tool 1 need not include state detection device 40. Control device 15 may determine the state of machine tool 1 based on external information such as input information from the management device or the user and display the button information of display switching button 115.
Control device 15 need not display characters 121.
Further, in the above-described embodiment, the operations related to tool magazine 25B, tool changer 25D, tool spindle device 21, and tool T2 are adopted as the series of operations of the present disclosure, but the present disclosure is not limited to this. The series of operations of the present disclosure may be a series of operations executed by other devices such as left and right spindle devices 12L and 12R, left and right turret devices 13L and 13R, and workpiece conveyance device 14.
Left and right machining devices 11L and 11R are not limited to the facing biaxial-type lathes, but may be parallel biaxial-type lathes. Left and right machining devices 11L and 11R may have various configurations such as a horizontal lathe, a front lathe, a vertical lathe, a machining center, a milling machine, and a ball machine.
Further, machine tool 1 may include a single lathe or a tool spindle device without including the combined machining machine 27.

### REFERENCE SIGNS LIST

1: machine tool, 3: operation panel (display operation device), 15: control device, 21: tool spindle device, 21A: spindle head, 25B: tool magazine, 25C: shift device, 25D: tool changer, 111: button operation screen (screen), 113: individual operation button, 115: display switching button, 115A: previous stage display switching button, 115B: subsequent stage display switching button, 121: characters (information indicating stage), T2: tool, P11: indexing position, P3: tool exchanging position, W: workpiece

1. A machine tool comprising:
a display operation device; and
a control device configured to display multiple individual operation buttons and a display switching button on the display operation device and execute control indicated by the multiple individual operation buttons and the display switching button in accordance with an operation performed on the multiple individual operation buttons and the display switching button,
wherein the multiple individual operation buttons are buttons configured to provide an instruction of a series of operations executed by the machine tool in multiple stages, and
the control device displays button information indicating the individual operation button in accordance with a state of the machine tool among the multiple individual operation buttons on the display switching button, switches the button information displayed on the display switching button in accordance with an operation of executing the display switching button, and switches the button information in order of the series of operations.

2. The machine tool according to claim 1,
wherein when the multiple individual operation buttons and the display switching button are displayed side by side in one screen in the display operation device and an operation of executing the display switching button is received in a state where the button information is displayed, the control device sets the individual operation button indicated by the button information to a display mode in which control indicated by the individual operation button is being executed.

3. The machine tool according to claim 1,
wherein when an operation of executing the display switching button is received, the control device transitions the state of the machine tool to a stage corresponding to the individual operation button indicated by the button information being displayed on the display switching button, does not change the button information being displayed on the display switching button during the transition of the state, and switches the button information displayed on the display switching button to the button information of the next stage when the transition is completed.

4. The machine tool according to claim 1,
wherein when, as the display switching buttons, two display switching buttons of a previous stage display switching button indicating a previous stage in the order of the series of operations and a subsequent stage display switching button indicating a subsequent stage in the order of the series of operations are displayed on the display operation device and the series of operations is stopped, in the series of operations, the control device displays the button information indicating the individual operation button corresponding to a previous stage of the stopped state on the previous stage display switching button and displays the button information indicating the individual operation button corresponding to a subsequent stage of the stopped state on the subsequent stage display switching button.

5. The machine tool according to claim 4, further comprising a state detection device used to detect the state of the machine tool,
wherein, in accordance with the stop of the operation of the machine tool, the control device detects the state of the machine tool by the state detection device, determines a stopped state of the series of operations based on the detected state, displays the button information on the previous stage display switching button and the subsequent stage display switching button based on a determination result, and does not display the button information of the previous stage display switching button and the subsequent stage display switching button when the stopped state is unknown as the result of the determination.

6. The machine tool according to claim 4,
wherein the control device displays information indicating a first stage of the series of operations around the previous stage display switching button and displays information indicating a last stage of the series of operations around the subsequent stage display switching button.

7. The machine tool according to claim 1, further comprising:
a tool spindle device configured to execute machining on a workpiece by a tool detachably attached to a spindle head;
a tool magazine configured to accommodate the tool for exchanging and index the tool for exchanging at an indexing position;
a tool changer configured to execute exchanging between the tool for exchanging arranged at a tool exchanging position and the tool attached to the spindle head; and
a shift device configured to convey the tool for exchanging from the indexing position of the tool magazine to the tool exchanging position,
wherein the series of operations is at least one of an extraction operation of extracting the tool for exchanging from the tool magazine and conveying the extracted tool for exchanging to the tool exchanging position and a return operation of returning a used tool removed from the spindle head by the tool changer to the tool magazine.
